(19) United States
(12) Patent Application Publication
(10) Pub. No.: US 2014/0244520 A1
(43) Pub. Date: Aug. 28, 2014

(54) METHOD OF MANAGING A CROWDSOURCE SCOUTING SYSTEM

(71) Applicants: Scott Hunter Wurtele, Sidney (CA); Paul Edward Wagorn, Victoria (CA); Daniel Jonathan Knopp, Whistler (CA)

(72) Inventors: Scott Hunter Wurtele, Sidney (CA); Paul Edward Wagorn, Victoria (CA); Daniel Jonathan Knopp, Whistler (CA)

(73) Assignee: IdeaConnection Ltd, Victoria (CA)

(21) Appl. No.: 13/781,213

(22) Filed: Feb. 28, 2013

(51) Int. Cl. G06Q 50/18; G06F 17/30

(52) U.S. Cl. CPC G06Q 50/184; G06F 17/30283
USPC 705/310

(57) ABSTRACT

A system and method of managing a server based multi-member or crowdsourced scouting process for client sponsored technology, product, or prior art searches. Clients submit search requests with non-confidential and often confidential parts, and associated search constraints, often via electronic client workspaces. This is stored in the system database. Members and their associated member information are also stored in the system database. Potentially interested members are contacted, given non-confidential information, and NDA submitting members then are provided with any confidential part of the search. Members then utilize their own networks to generate search leads. Member submitted leads are then evaluated either automatically or via administrator system dashboards, and passing leads given to clients for review or approval. Efficiency is enhanced by allowing various types of member-client feedback during the process. Funds or other rewards are dispersed to those members who submit client approved leads.

### BACKGROUND OF THE INVENTION

1. Field of the Invention

This invention is in the field of Internet based computerized crowdsource management systems for scouting/searching for difficult to find licensable technology, suppliers of products or services, or finding prior art for intellectual property.

2. Description of the Related Art

Computer network based systems have been used for various search purposes almost from the beginning of the computer era. However most prior art in this area has focused on the problem of using computers to search for information that is already stored in electronic form, generally in computer databases that are accessible to the searcher.

Examples of prior art in accessing information in non-electronic form includes Information Express, Menlo Park, Calif. Originally founded in 1985, Information Express allows corporate clients to call or phone in requests for paper documents, often research publications found in various library copies of various research journals. Information Express in turn engages various human agents/employees/contractors to go into libraries, photocopy journal articles, and then fax, email or mail the retrieved journal articles to their various clients.

As the cost of computers has decreased, and the popularity of the Internet has increased, various Internet based computer systems to allow clients with difficult search problems to outsource these problems to various third party contractors have also become popular.

Examples of two such popular systems in widespread use today include Tsatalos, US patent publication 20060284838, assigned to oDesk® Corporation; and Sheth, US patent publication 2001/0032170, and U.S. Pat. No. 7,069,242 both assigned to Elance® Corporation. Both allow clients to specify various types of searching jobs, and to solicit members of oDesk or Elance to help provide requested search information.

More recently, a method of distributed problem solving and searching called “crowdsourcing” has also become popular. Crowdsourcing generally operates by using an Internet based computer system to solicit ideas and services and search requests from large groups of generally undefined individuals (i.e. the general public). In recent years, various organizations, such as Innocentive, Inc., have utilized various crowdsourced computer implemented methods to search for items of interest to various corporations. Some of the technology behind the Innocentive approach is exemplified by Bingham et. al in US patent publication 20040054582, Carroll in US patent publications 20070244840, and 20070239464 and Spradlin et al in US patent publication 20090299760.

Despite these advances, there are a number of aspects of such prior art systems that are less than ideal for many situations. Thus further advances in this art would be commercially important.

### BRIEF SUMMARY OF THE INVENTION

In one embodiment, the invention may be a computerized system and method of managing a crowdsourced, multi-member scouting/searching (here the terms “scouting” and searching will be used in the alternative) process. The method may be a software implemented method, typically run through at least one computer processor (e.g. one or more microprocessors) on one or more Internet web servers. These servers will typically exchange information with various network connected computerized devices under the control of various members, clients, and optionally system administrators.

The invention typically operates by storing information pertaining to a plurality of human members in a member computer database. The invention will generally also provide each member with their own electronic workspace (unique member electronic workspace). This will often be done by providing one or more member webpages that are only accessible by that member's computerized device, usually though a password system.

The system will also provide a private electronic client workspace, again usually provided as one or more private client webpages, by which clients can submit scouting requests for various search items. Such scouting requests can include requests for licensable technology searches, providers of goods and services, requests for prior art citations, searches for collaboration partners, searches for proposals, and the like. In some embodiments, even various headhunting searches (e.g. positions available searches, candidate employee searches, executive searches, and the like) can be done according to the invention.

The invention's method and system will generally store a plurality of these client submitted scouting requests in a client scouting request computer database. To maintain confidentiality and to make the method commercially viable, each client submitted scouting request may have a non-confidential part, an optional confidential part, optional request constraints, and usually an amount to be paid (payment amount) for those members that submit acceptable search results.

In one embodiment, the invention's software will generally operate on one or more servers (e.g. web servers) by using the client scouting request and the various associated request constraints to search the member computer database to prescreen the member database for those pre-selected members that have associated member information that satisfies the request constraints (e.g. members that satisfy various educational level, employment history (e.g. conflicting employment check), location, track record of success criteria, and the like). Those members that pass this pre-selection will then be sent the non-confidential part of the scouting request.

Alternatively, when member pre-screening or pre-selection is not desired or required by the client, such as when the client wishes to cast as “broad a net” as possible, the invention may alternatively or additionally display the non-confidential part of the scouting request on a web page that may be available to many or all members, or even the general public.

In either event, for those members that respond with interest, the system will often then transmit a more detailed scouting invitation, as well as often an unsigned nondisclosure agreement (NDA) (which may be a form to sign and return, or a click box to check, and the like). In this case, upon receipt of the physically or electronically signed or otherwise affirmed NDA agreement the system will generally transmit any additional confidential part of the scouting request to these NDA responding members.

To enable system administrators to see the progress of various scouting/searching projects, as well as to monitor and control overall system performance, often the system will create a list in dashboard graphical user interface (GUI) (often also in the form of one or more webpages or screens). This list will often include at least the status of those members who have indicated interest in a given search. This administrator dashboard GUI will also typically present other relevant information to system administrators, such as the date of a member's scouting request lead submission, link to the member's scouting request lead submission, verification status of the member's scouting request lead submission, client acceptance of the member's submission, NDA signing, and the like.

To improve the quality of performance, the system will often employ various procedures to verify that a given member's scouting request lead submission is likely to be satisfactory. This can include automated (or administrator audited) tests to ensure that any given lead submission passes various client request constraints, as well as various system default constraints as well. These system default verification constraints can include such things as internal submitted form consistency checks, member and lead email and address verification checks, and the like.

In some embodiments, for applications such as for prior art searches, the system may also be configured to perform automated verification of lead submitted documents through various Internet search engines to determine if the titles submitted are readily available through normal searches. In such cases, depending on system and client preferences, the system may be set to screen out or otherwise exclude such normal search available citations either upon initial lead submission, or before forwarding the potential lead to a client.

Once promising leads have been received and usually at least partially verified, the system will generally then, either automatically, or assisted by the dashboard GUI, transmit the appropriate scouting request lead submissions to the client's electronic client workspace, and request client approval or other feedback.

In some embodiments, when a submission is submitted, the client can also be notified via email, SMS message, phone call, or other notification process optionally also provided with a URL link to view the submitted lead. This can remind clients to check their client dashboards.

Upon client approval of the relevant scouting request lead submission, the system will then notify at least the member or members that submitted the winning lead. In some embodiments the system may then also at least set into motion the subsequent steps involved in transmitting the payment amount or other reward to those members that provided the useful scouting request leads. For example, the system can then either automatically, or with administrator oversight and approval, then request bank or other financial institution to send funds to the successful members via check or electronic funds transfer.

### BRIEF DESCRIPTION OF THE DRAWINGS

FIG. 1 shows an overview of how the invention's Internet server based system and methods operate.

FIG. 2A shows an example (top part) of a blank client technology scouting electronic request form.

FIG. 2B shows a further example (lower part) of the blank client technology scouting electronic request form.

FIG. 3A shows an example (top part) of a partially filled out technology scouting electronic request form to find a supplier for a particular type of power supply. Here the request was previously filled out by the client using a client form, and is now being viewed from a system administrator's dashboard web page. The system administrator may, for example, optionally review edit or rewrite client information as needed.

FIG. 3B shows a further example (middle part) of the partially filled out technology scouting request to find a supplier for a particular type of power supply, again being viewed from a system administrator's dashboard webpage.

FIG. 3C shows a further example (lower part) of the partially filled out technology scouting request to find a supplier for a particular type of power supply.

FIG. 4 shows an example of a dashboard Graphical User Interface (GUI), webpage for a system administrator. This page shows that a number of different members or scouts (here called “teams”, even though each team is just one member) are working on the high voltage power supply scouting request.

FIG. 5 shows a web page showing the confidential portion of this power supply technology scouting request, as seen by a member who has previously expressed interest in this scouting request, and who had previously submitted an appropriate NDA agreement.

FIG. 6 shows how the non-confidential portion of this power supply technology scouting request can alternatively or additionally be displayed on the system's website for non-preselected members, or even the general public, to see. This page also shows a number of other technology scouting requests, prior art citation search requests, and even a candidate search request.

FIG. 7A shows the first part (top) of a response form that a search participating member may use to submit a possible lead for the power supply technology scouting request.

FIG. 7B shows the second part (bottom) of a response form that the member may use to submit a possible lead for the power supply technology scouting request.

FIG. 8 shows an administrator dashboard webpage or screen where that member's submitted search lead can be viewed and the status of that member's lead submission verified.

FIG. 9 shows a screen or webpage from the client's electronic client workspace, in which that member's particular power supply lead submission can be viewed by the client.

FIG. 10 shows a screen or webpage from the client's electronic client workspace which the client can use to review the acceptability of that member's particular submission.

FIG. 11 show other screens or webpages from the client's electronic client workspace, in which the high level status of their power supply search request and other requests can be evaluated.

FIG. 12 shows a screen or webpage from the client's electronic client workspace, from which client can see an overview of all member submissions for this particular power supply search request.

### DETAILED DESCRIPTION OF THE INVENTION

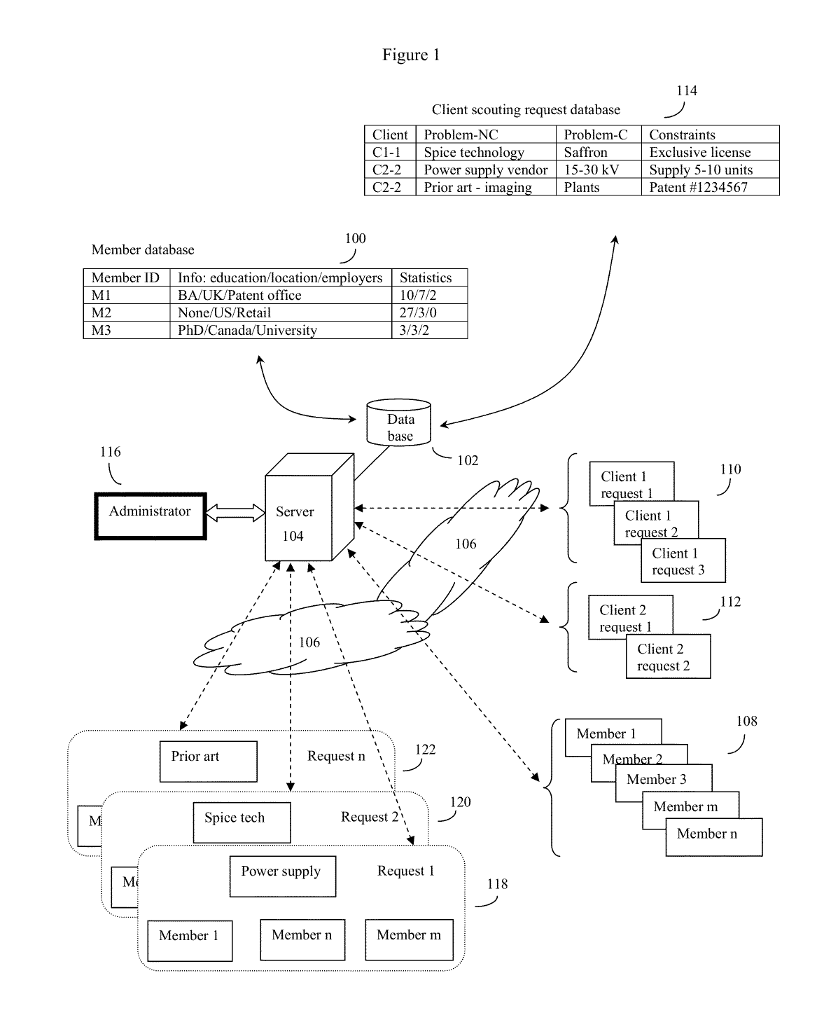

FIG. 1 shows an overview of how the invention's Internet server based system and methods operate.

As previously discussed, the invention is a computer implemented method, and the various methods described herein will typically be software implemented methods. These methods will typically operate via a web server with at least one computer processor, such as an Internet web server (104). This server will be connected over a computer network (such as the Internet 106) to various member and client computerized devices (e.g. desktop computers, laptop computers, tablet computers, smartphones and the like).

In general, the invention's software implemented methods will run on server (104), and direct server (104) one or more processors to perform various functions, such, as will be discussed, providing an electronic client workspace or unique member electronic portal as one or more web pages or app screens over the Internet. In general, both clients, members, and optionally also system administrators will interact with their respective electronic client workspaces, unique member electronic portal, or dashboard graphical user interfaces (GUI) over a computer network, such as the Internet using web browsers or application software running on various client, worker, or administrator computerized devices connected to the network.

In one embodiment, the invention may be a computer software implemented system and method for managing a crowdsourced (e.g. multi-member) based scouting process for various types of scouting searches. That is, each search will generally not be a direct search of a computer database, but rather each search will be conducted through one or more human members, who may optionally in turn search their own personal networks of friends or colleagues.

According to the method, generally the system will, as members (108) register, maintain a standing database of members (100) on one or more memory storage devices (102) (e.g. hard drives, flash memory, and the like). This member database may have a core group of reoccurring member contributors, as well as new members that may have recently signed up either before, during or after any given scouting request has been submitted by any given client.

Members or potential members may also be given the option allowing the system to verify aspects of their background, such as security clearances, criminal background, educational background or license checks, and the like. Additionally, potential members with associated statistics (e.g. country of origin, expertise, employment status) indicating that increased scrutiny may be desirable can additionally be subjected to additional background checks as desired. Thus for example, if too many potential members sign up as being former Nigerian princes (statistically associated with scammers), then the system may determine that higher levels of verification may be needed before full member status is granted.

The member database (100) will generally store member names, member identification numbers, contact information, and associated member information (e.g. the member's respective educational background, address or location, current employer and/or employment history and the like). This member database may be used by the system (104) to help provide each member with their own unique workspace, as needed.

Generally as clients (110) register with the system, the system will also provide, generally on a per-client basis, an individualized or unique (e.g. per client) electronic client workspace for their various scouting requests. These workspaces, often server (104) provided web pages or app (application) screens, will be used to obtain various client submitted scouting requests. These client scouting requests will be stored in a client scouting request database (114). As previously discussed, often, each such client scouting request will have a non-confidential part, a confidential part, various request constraints, and a payment amount. Note however that as desired, client requests can be purely non-confidential, purely confidential, have no constraints, and can even have no payment amount (or implement payment via a non-monetary method such as signing up successful scouting lead submitting members to a lottery, honoring them, and the like).

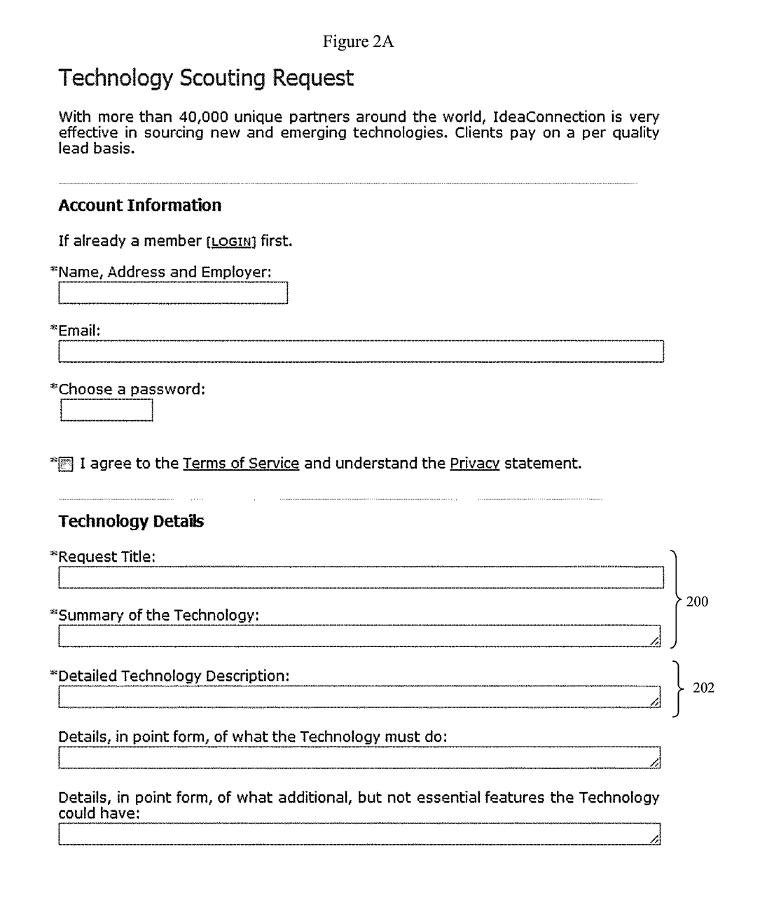

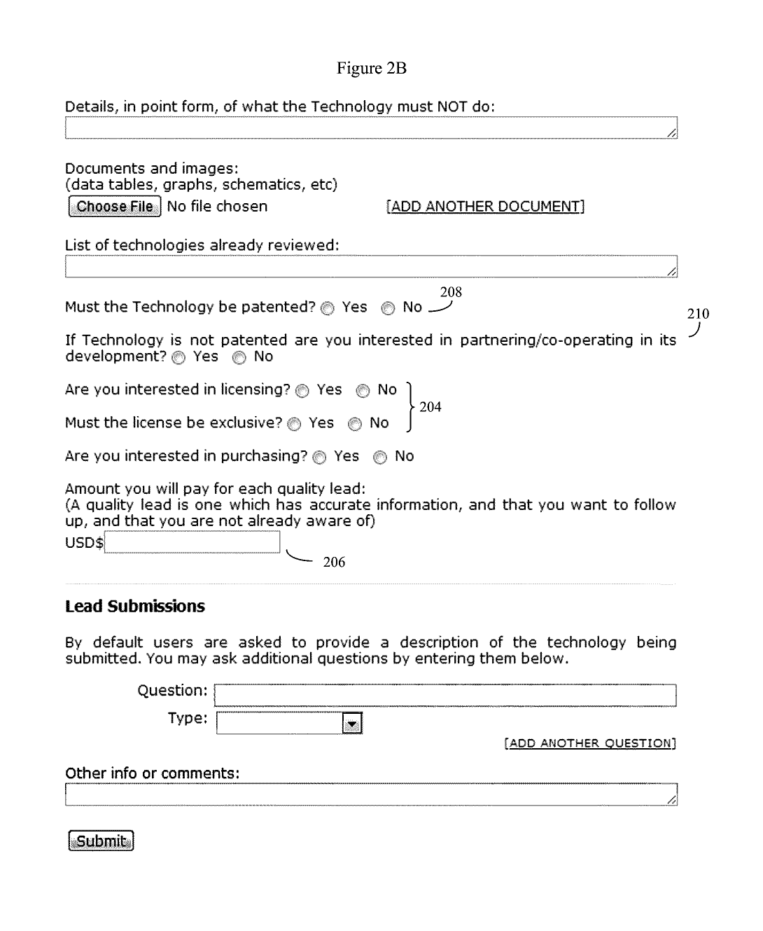

FIG. 2A shows an example (top part) of a blank client technology scouting request electronic form. This form may, for example, be used by a client who may have its own manufacturing or service capability, but who wishes to obtain or license technology to extend the range of products or services that this particular client provides. This type of form can provide a place where the client can provide a non-confidential outline of the scouting/search request title and summary (202), as well as a more detailed description that may optionally be confidential (202).

This electronic form may be provided by server (104) by various methods. For example, it may be provided as a link that a client can click on in a client workspace, or even (e.g. for clients who are new to the system) as part of a general website page initially accessible to all.

FIG. 2B shows a further example (bottom part) of the blank client technology scouting request form. Note that the form contains entry points for various scouting request constraints. For example the client can specify in (204) that the client is only interested in obtaining exclusive licenses. The client can also specify various other factors, such as how much members that submit good leads will be paid (206). The client can also provide information pertaining to what searches have been previously been done to help avoid unnecessary duplication of effort.

Once a client obtains a blank electronic technology scouting request form or other type of scouting request form, the client will then fill it out, often using a web browser on the client's computerized device, and submit this filled out scouting request form to server (104), where it usually will be associated with that client's profile in the client scouting request database (114).

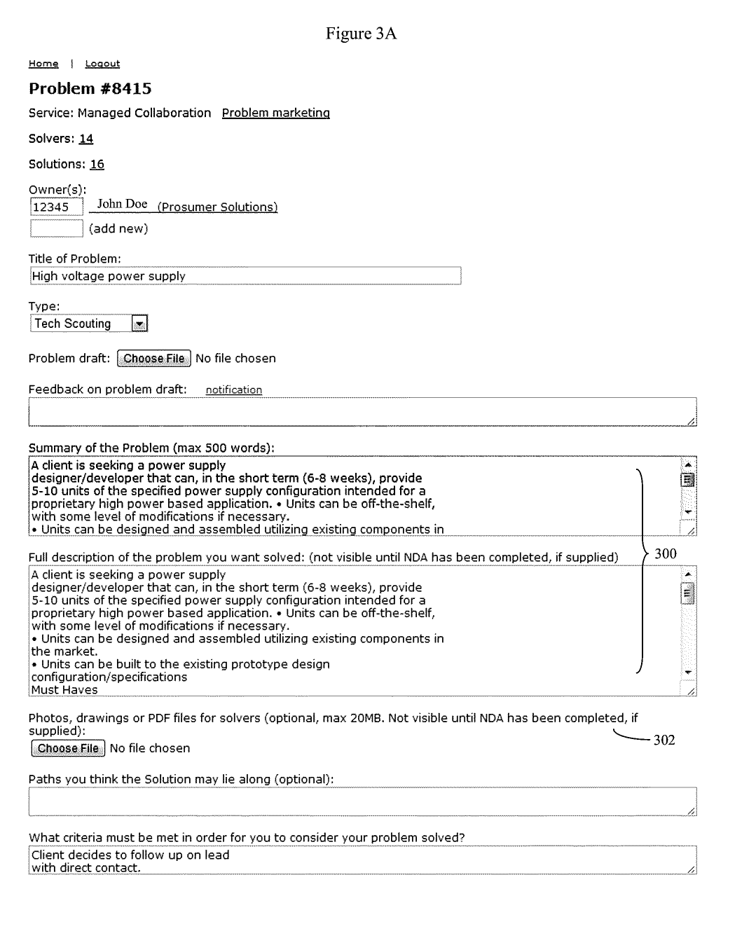

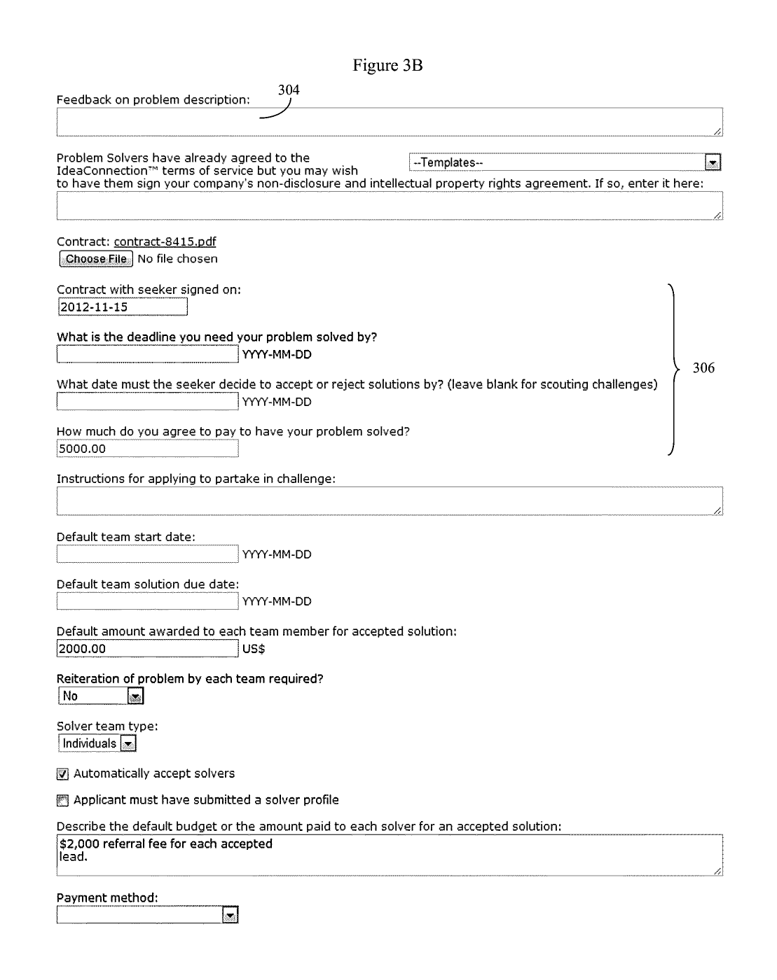

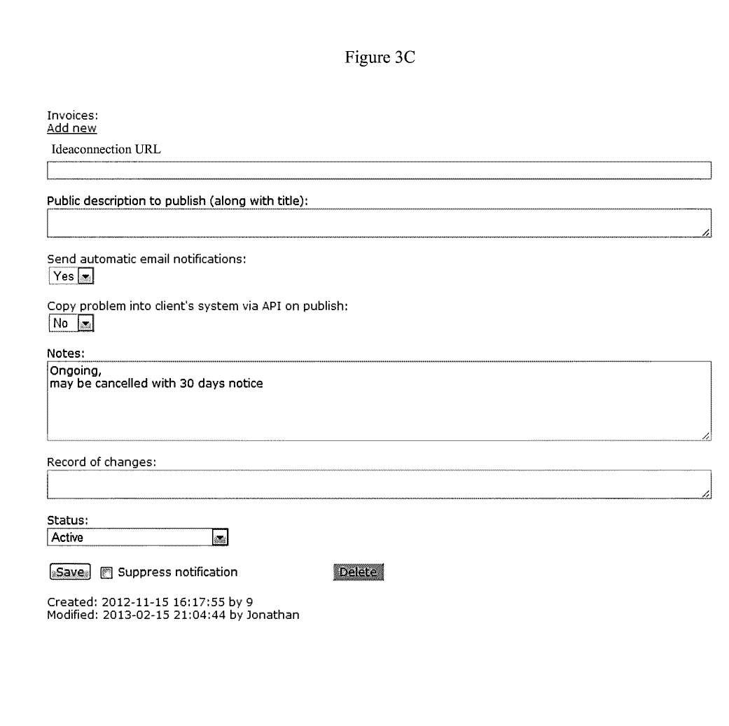

Once the completed client scouting request is in database (114), it then can be used for various purposes. As one simple example, a system administrator (116) can call up this form on a dashboard graphical user interface (GUI) webpage or app screen, and review the client's scouting request. An example of this is shown in FIGS. 3A-3C.

FIG. 3A shows an example (top part) of a partially filled out client technology scouting request for a somewhat different type of search. Instead of looking for licensable technology (e.g. intellectual property), in this example the client is instead trying to find a commercial supplier for a rather unusual type of power supply (300). To find suppliers of products or services, the system may provide the client with blank electronic search request forms that, although generally similar to the examples previously shown in FIGS. 2A and 2B, may also have a few differences.

Among other functions, such as letting the administrator review both the non-confidential (300) and confidential (302) portions of the search request, the system can additionally (either automatically—e.g. by checking various form fields for completeness, or semi-manually—e.g. by a human administrator 116) review the client input and give feedback to the client when corrections are necessary. The administrator can additionally request other search management housekeeping information from the client at this time as well.

FIG. 3B shows a further example (middle part) of the partially filled out technology scouting request to find a supplier for a particular type of power supply, here again being viewed from the dashboard of a system administrator.

The system may be configured to also allow participating members to give feedback (304) to the clients regarding questions that these members may have regarding the various client submitted scouting/search parameters. For example, if the client request is unclear or ambiguous in certain sections, member feedback can help the client refine the search.

Although in some embodiments, such member feedback may be submitted automatically back to the client without further administrator intervention, in other embodiments, some level of administrator review or editing of such feedback may be desirable. Here forms such as FIGS. 3A, 3B and 3C optionally allow the administrator review and edit (300) or otherwise have optional manual control over this member feedback. The administrator can also use these forms, or other forms as desired, to provide administrator feedback to the client.

These forms may additionally allow the administrator to remind the client that additional non-disclosure agreements or intellectual property rights agreements are available, agree on various project total costs and deadlines with the client, and the like (306).

FIG. 3C shows a further example (bottom part) of the partially filled out technology scouting request to find supplier for a particular type of power supply. This part of the form allows the administrator to adjust various automatic system software parameters for this particular problem.

As previously discussed, the scouting requests or search requests can be for various topics, such as licensable intellectual property, requests for quotations from providers of goods or services, prior art searches, or even headhunting (employee recruiting) purposes. Here the system will usually be configured to allow the client to specify various constraints on what type of search leads will be acceptable. Typically there will at least be a requirement for contact information for leads relating to the owners or managers of the licensable intellectual property or the providers of products or services.

In some embodiments, the scouting requests/search requests can also be for prior art citations, such as patent prior art citations. Here the system may be configured to allow the client to specify other constraints. For example, these constraints may be that the search leads must comprise either an electronic link to the proposed lead's prior art citation, and/or an electronic copy (e.g. a pdf scan of a document) of the proposed prior art citation.

Alternatively, for situations where the citation is not available in electronic format, such as a PhD dissertation held on a university library shelf, the system constraints may be relaxed to allow for other forms of submission as well.

Additionally, the system can also be configured to allow the client to specify additional constraints regarding the member's geographic location (e.g. address), and/or constraints on the member's present or past employers (e.g. no members from competitor companies will be accepted), and/or constraints on the member's educational level, major, field of expertise, and the like. Present or past employer constraints may be particularly useful for prior art citation situations, where ongoing or potential legal actions may render members from some present or past employers unsuitable.

With regards to member constraints, note that the system generally operates on a “network of networks” basis. Thus even if a given member may not have special expertise in a given scouting/search area, that member may nonetheless have a personal acquaintance, friend or other contact who does have the required expertise. Thus it will not always be in the client's best interest to specify narrow constraints on the member's educational level and field of expertise. However, particularly in cases where the subject matter is complex and/or too many unproductive leads have been or are being generated, then further member constraints may be employed to reduce the background of irrelevant lead submissions.

With regards to network of network embodiments, in some cases, at least with proper member authorization, the system may perform further automated scans of a given members online social networks, and utilize this “network of networks” directly. This may be useful for helping to ensure that messages to and from various individuals in this network of networks are properly transmitted and received.

The client may impose other constraints as well. For example, the client may impose additional constraints that scouting any request lead submissions further to be patented or potentially patentable technology (FIG. 2B 208), to owners who are interested in partnership (FIG. 2B 210), licensing, exclusive licensing, interest in providing products, or interest in providing services. Other options, such as interest in merger and/or acquisition, can also be provided.

As previously discussed, members who might be interested in participating in any given search can be found by more than one method. As a first method, often appropriate for more sensitive scouting requests/searches, a more private member notification and selection process can be done. This is particularly useful when in-depth knowledge of the subject matter is required.

Additionally, some clients, such as security agencies, may wish to engage in further member screening, such as cross checking and screening out members with a problematic legal background, or preferentially only using members with security clearances or other assurances. Here, those members who wish to participate in such types of searches can, for example, consent to such pre-screening and these members in turn would in-turn likely be rewarded with additional client business.

Here, for this more exclusive type of process, once the scouting request and request constraints have been established, the system can use the scouting request and request constraints, previously stored in the client scouting request database (FIG. 1, 114) to search the member computer database (FIG. 1 100) for those with associated member information that satisfies the request constraints. These members will be designated “pre-selected members”. The system can then transmit at least the non-confidential part of the scouting request to these pre-selected members as a scouting/search project notification.

For example, relevant to the power supply provider search example, if the client C2-2 believes that it will receive too many useless or improper leads if there are no search constraints, the client could specify that it only wants members with advanced educational degrees, working at non-competitive employers, to participate in the search. Given these constraints, when a computer processor in server (104) searches the member database (100), it will determine that member ID “M3”, a PhD working at a university, and others like member M3 satisfy the client constraints. These members would thus be suitable (pre-selected) search members, and the scouting project notification might only go out to these members.

As a second and less exclusive method, often appropriate for less sensitive scouting requests/searches, a more open or even public member notification process can be done. Here the system server (104) can display the non-confidential part of the scouting request on a web page available to some or all of system members, or even to the general public at large.

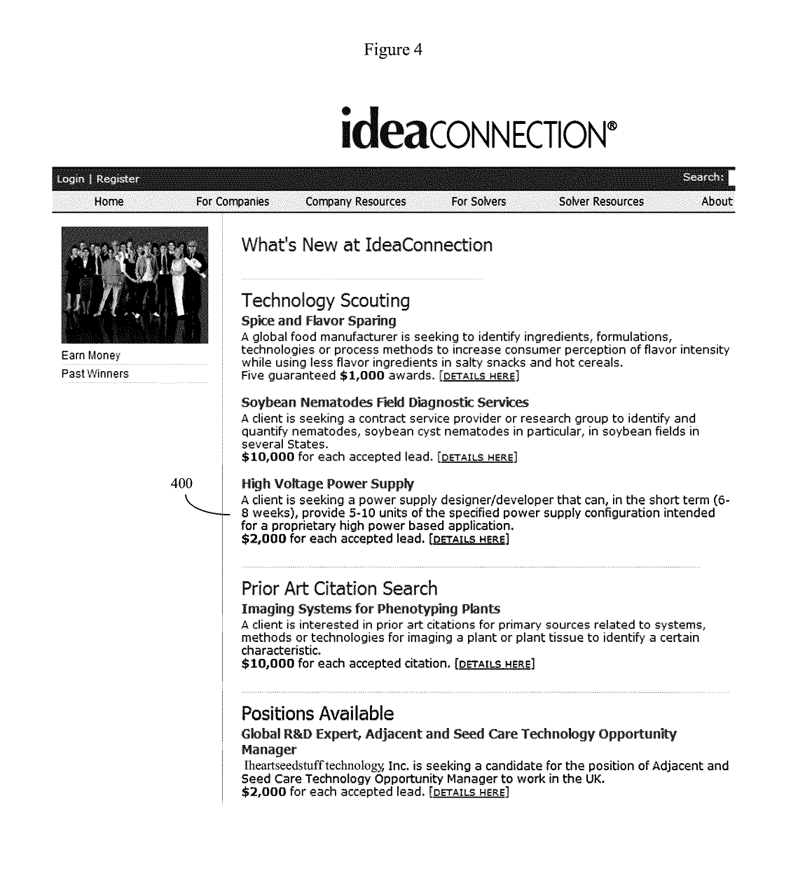

An example of such a non-confidential web page, that more broadly advertises various scouting request/search requests is shown in FIG. 4. Here, the non-confidential portion of the power supply technology scouting request (400) is provided by server (104), and is being displayed on the system's website, along with other technology scouting requests, prior art citation search requests, and even candidate search requests. Non-members who see this request and are interested can sign up for the system, thus becoming members registered in member database (100) themselves.

Those members that either receive a private scouting notification, and/or who see a more general website posting (400) can then use their respective computerized devices to electronically transmit an indication of interest to server (104). These potentially interested members will be termed “responding members”.

The system can then optionally (depending on client preference for confidentiality) transmit a scouting invitation comprising, for example, an unsigned NDA agreement, which the interested members can then physically or electronically sign or affirm. Upon receipt of this signed NDA agreement the system can then transmit the confidential part of the scouting request (if any) to these responding members who also signed NDA agreements. These responding members who also signed NDA agreements will be termed “NDA responding members”

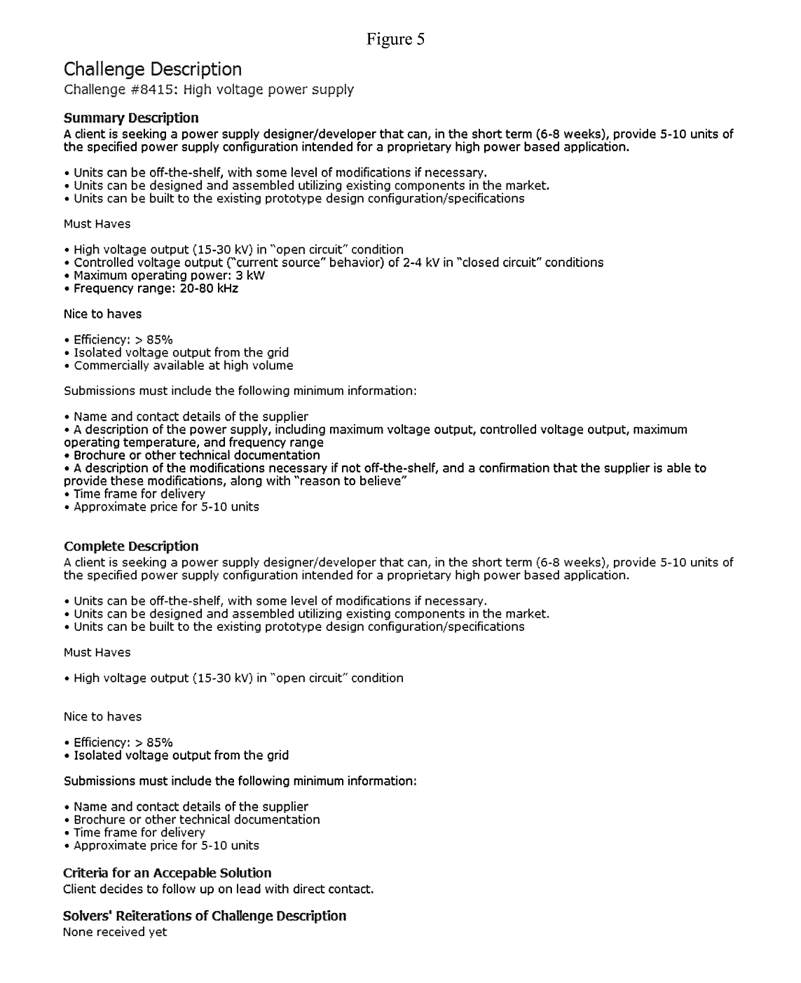

An example of an optional confidential part of the scouting request can be seen in FIG. 5. This figure shows a server (104) generated web page, generally accessible only to those responding members who were given appropriate system security clearance. This page shows the confidential portion of the example power supply technology scouting request. Again, this will generally only be seen by members who had previously expressed interest in this particular scouting request, and who had also submitted the appropriate NDA agreement.

In the event that the particular scouting request does not have a confidential portion, the same sort of FIG. 5 form, giving more detailed but non-confidential scouting request information, may also be provided to interested members who have not submitted a signed NDA.

At this point, the members who are continuing to participate in the search (e.g. NDA responding members) will go and use their own private network of contacts to attempt to find leads that satisfy the scouting request/search and various constraints. Here the members may use any and all means, including their own computerized social networks (e.g. Facebook, Twitter, Google+ and the like), real-world friends, their own computer searches, physical contact, searching libraries and books, going to various suppliers, and the like in an attempt to generate scouting request leads.

For example, assuming that this part of the search is not confidential, there would be nothing to prevent a given member from going onto the online social network Twitter, and asking his Twitter followers: “Anybody have a lead on high voltage power supplies?” and following up on any Twitter submitted suggestions. This is why the invention's methods may be termed or understood as being “network of networks” type methods, because the invention's network of members (first network) can in turn access their own individual network of contacts in order to find search leads (network of networks).

Eventually, at least some active (e.g. NDA responding members) will usually find and subsequently submit scouting request leads to server (104). For example, see FIG. 1 (118), which shows a group of members (member 1, member n, and member m) who are actively involved in the example power supply scouting request.

In some embodiments, the system server (104) may automatically return any and all member submitted leads to the electronic workspace of the relevant client, here client 2 request 2 (112) (see also client scouting request database 114). In other embodiments, however, it may be useful to provide an ability for a system administrator (116) to at least occasionally review these member submitted leads and edit or even redact as needed.

To do this, the system may be configured to use at least one computer processor, often in server (104) to display a list of at least those participating members (e.g. lead submitting NDA responding members) in an administrator dashboard GUI, often again as one or more administrator web pages or screens. Often this dashboard GUI will also display at least some information pertaining to the date of the various member's scouting request lead submission(s), link to the member's scouting request lead submission(s), verification status (if any) of the scouting request lead submission(s), as well as client review and hopefully acceptance of the various scouting request lead submissions.

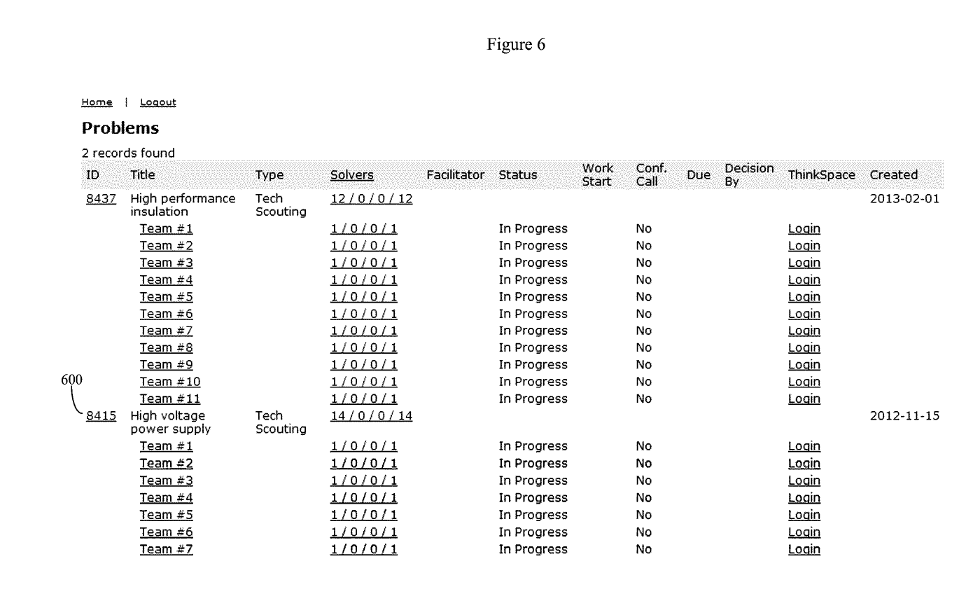

FIG. 6 shows an example of one page from such a dashboard Graphical User Interface (GUI), here showing that number of different members/scouts (here, because this particular dashboard can also be used for team management as well as per parent application U.S. Ser. No. 13/763,714, the contents of which are incorporated herein by reference, each individual member is in this example also called a “team”) are working on the high voltage power supply scouting request (600). This particular dashboard GUI has various clickable links allowing the administrator (116) to check on the status of any given member's submission.

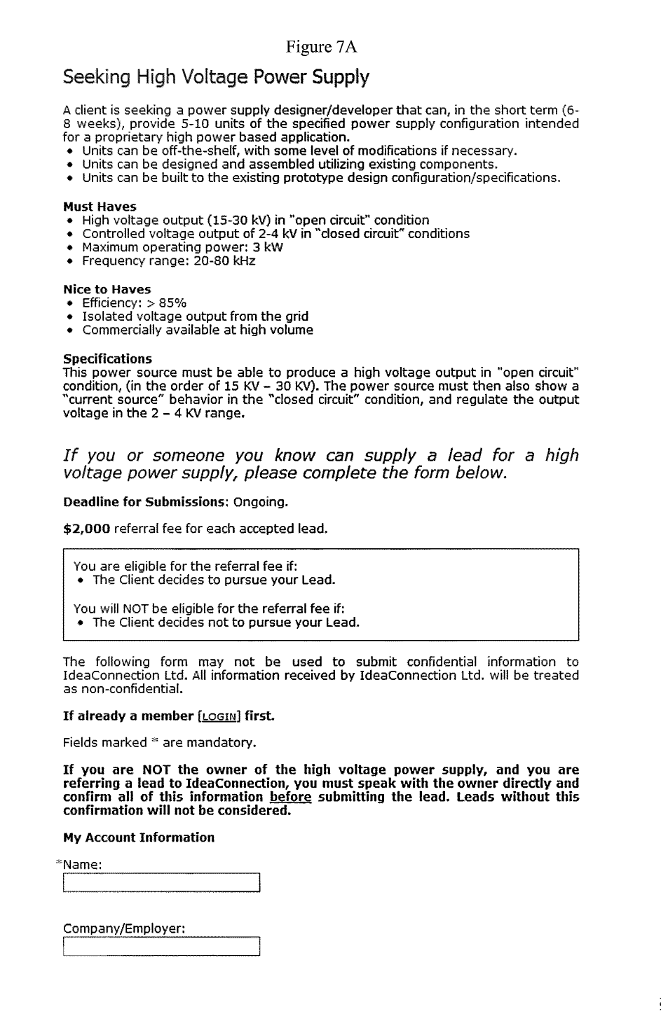

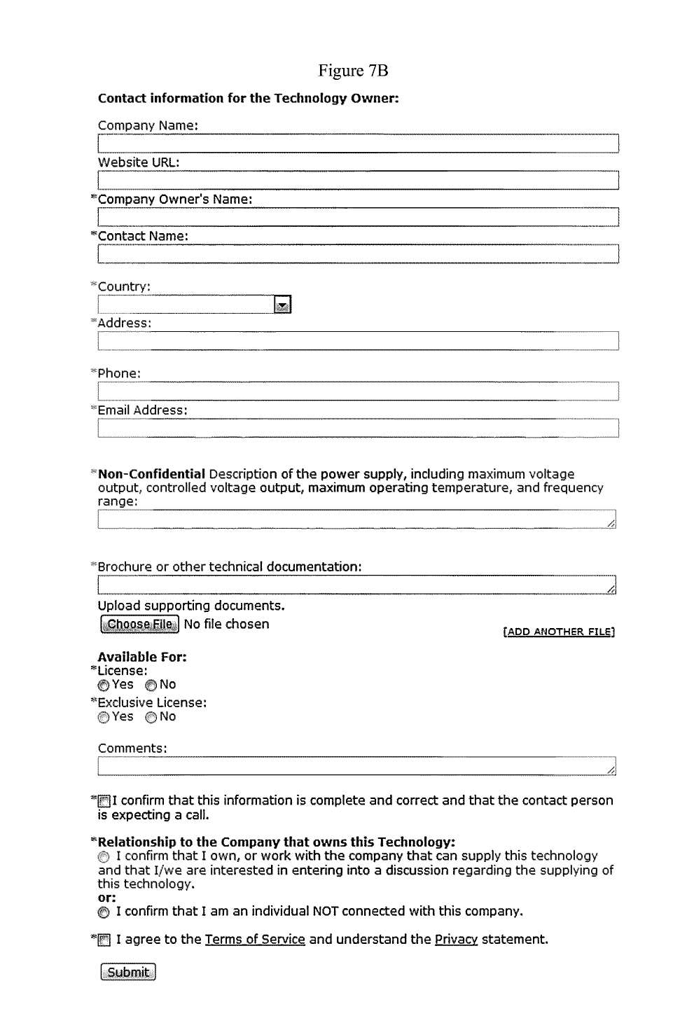

An example of a member lead submission form, here a general form, capable of being used for both confidential and non-confidential scouting/search projects, is shown in FIGS. 7A and 7B. Generally these response forms will be provided via that participating member's electronic member workspace, often in the form of web pages or app pages containing electronic forms that can be filled in by the member and electronically submitted back to server (104).

FIG. 7A shows the first part (top) of the lead response form that a member may use to submit a possible lead for the power supply technology scouting request. Here, in this example, the response form first reiterates the power supply scouting request, and then invites the member to fill in the lead information for that search, and submit the lead.

FIG. 7B shows the second part (bottom) of the lead response form that a member may use to submit a possible lead for the power supply technology scouting request. Here for example, the member can give the required contact information for a company that may be able to satisfy the power supply search, along with various types of supporting information regarding the power supply and the company.

As previously discussed, the system may either automatically, semi-automatically, or manually (through the administrator dashboard) then verify that the various scouting request lead submissions indeed pass the various search request constraints, as well as various system default constraints as well.

The type of verification used may differ depending upon the search problem at hand. When, for example, the scouting requests are for licensable intellectual property or for requests for quotations from providers of goods or services, then the verification process can comprise either automatically or manually contacting the owners or managers provided by the member's lead, and requesting that these owners or managers affirm the information provided in that particular member's scouting request lead submission.

The verification can also comprise using the member lead provided contact information to electronically and often automatically search at least one of the websites, patents, patent applications or publications identified by the lead contact information for various parameters, such as key words from the non-confidential or confidential part of said scouting requests. For example, for the power supply scouting request example, the server (104) may automatically read the website of the lead company, and determine if key words such as “power” “manufacturing” “electrical” and the like appear on the lead submitted website. If the submitted website is instead for a food company, these key words may be absent, and the system may automatically flag the administrator that there is a potential verification problem that warrants further administrator investigation. Conversely if the automated check of the website reveals key words totally consistent with the client's scouting request, then depending on system settings, and potentially also other factors such as the success rate statistics for that particular member, then the system server (104) may automatically forward that lead to the relevant client's electronic workspace.

Such automated verification processes are particularly useful for scouting requests/searches for prior art citations. This is because usually either a direct link to the prior art citation, or an electronic copy of the prior art citation, will be provided as part of the member submitted lead. Here the server (104) or other automated process can electronically search the electronic link or electronic copy of the prior art citations for key words from the non-confidential or confidential part of the scouting request, and if enough key words, or various heuristic types of keyword combinations, and/or various Boolean logic combinations of key words are present, automatically forward the citation to the client according to client desires and system settings.

In addition to client search request related verification steps, other verification steps, often common to many scouting requests in general, may be automatically provided by the system. An example of such “system default” constraints or verification steps may include requirements for consistent responses in any member (or client) submitted electronic forms, as well as automatic verification of submitted emails, phone numbers and URLs, and the like. Optionally, as desired, such verification can be audited or refined by the administrator (116) as well.

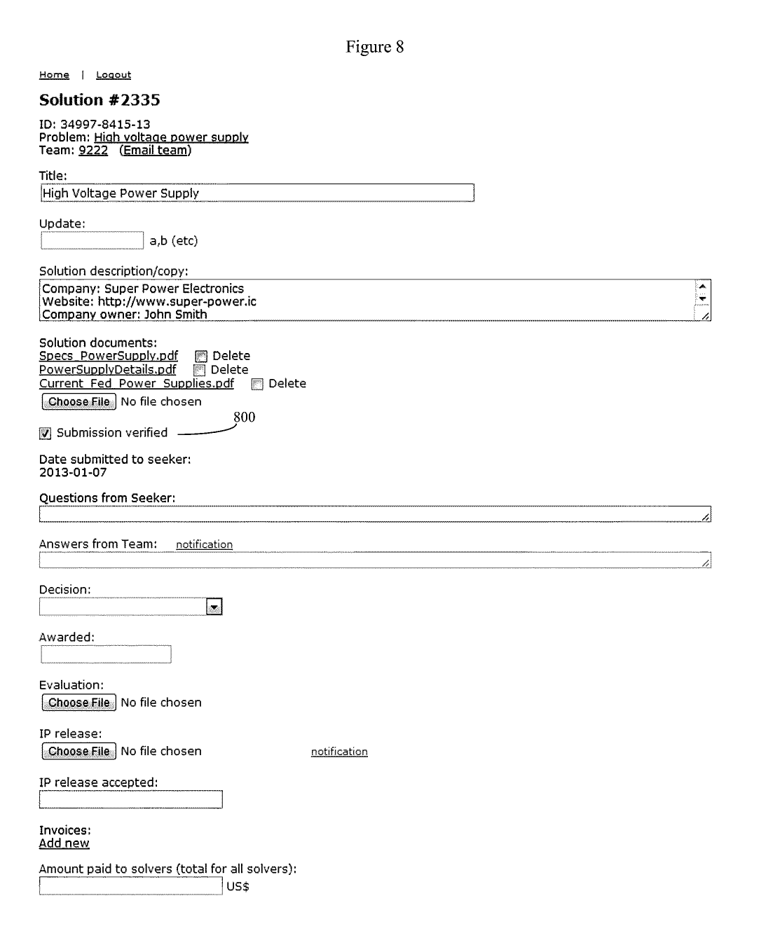

FIG. 8 shows a dashboard screen where a member's submitted power supply lead can be viewed by the administrator, and the status of this member's lead submission verified (800).

According to the invention, the clients (seekers) may optionally also use their electronic client workspace to answer questions and feedback from various participating members (e.g. NDA responding members). The clients in turn can make use of this feedback by in turn transmitting alterations or corrections for various parts of their scouting request (often the confidential part) to various members such as the NDA responding members. Again, this can be done automatically by server (104) electronically parsing submission forms from either the members or clients, and forwarding as appropriate. This can also be done by administrators using the various administrator dashboard web pages or screens provided by server (104) as well.

Often either automatically, or manually as determined by the administrator (e.g. using the dashboard GUI to transmit the passing scouting request lead submissions to the client's electronic client workspace), the system can then request client approval of those passing scouting request lead submissions that have survived these various levels of scrutiny.

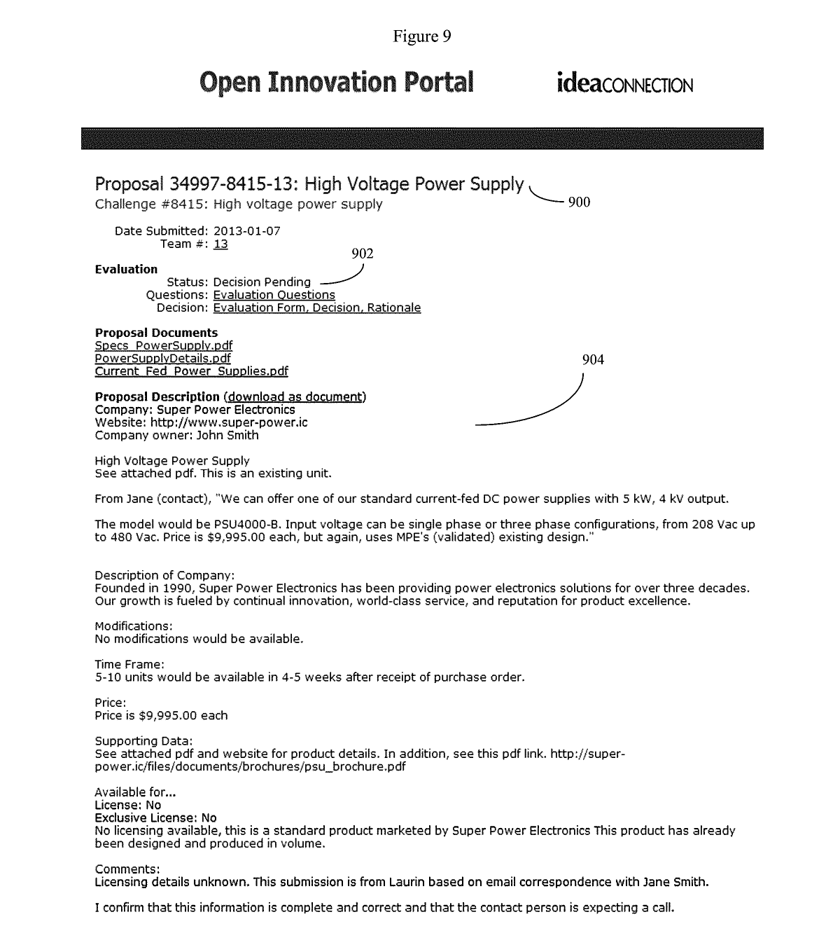

Here, an example of what the client will see in the client's electronic workspace (in this example called the “Open Innovation Portal” is shown in FIG. 9. In this example, the client workspace webpage, provided by server (104) is both reiterating portions of the client's original search request (900), reminding the client that a decision is due (902), and providing details from a particular member's (here this member is called “team 13”) lead submission.

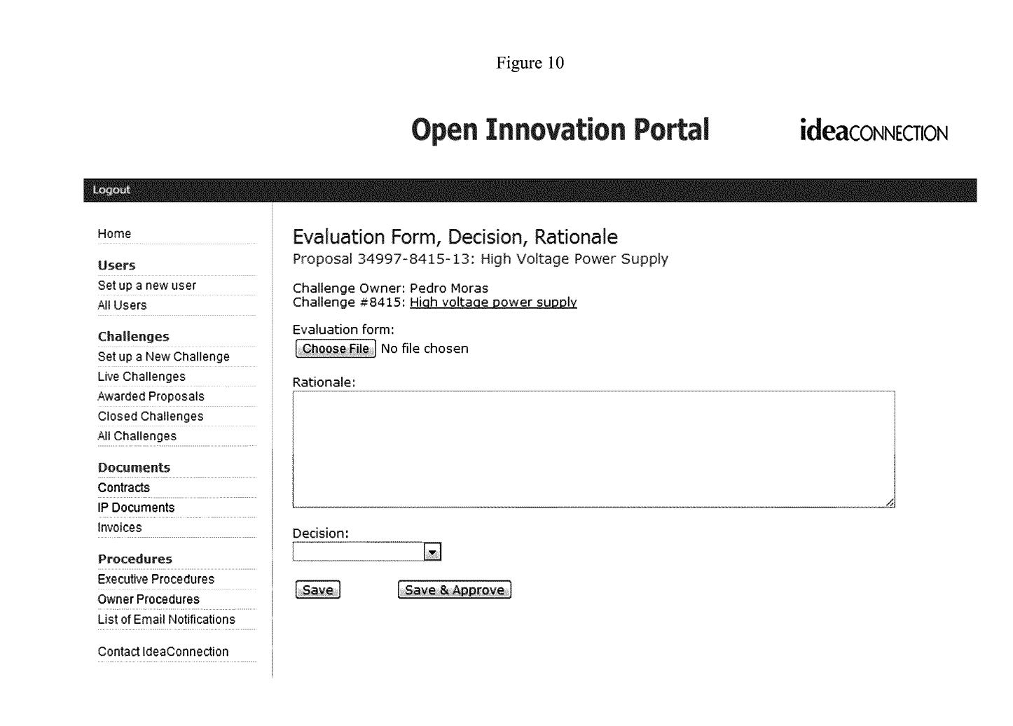

To provide feedback (e.g. accept, reject) a particular lead, the client can click on an appropriate area or webpage of that client's electronic workspace, and provide the requested decision. This is shown in FIG. 10, which shows an example of a screen from the client's electronic client workspace where this client can review and submit the client's evaluation of acceptability of this particular member's lead submission.

Clients, in particular larger organizations, may often have multiple scouting/search requests, and each scouting/search request may be handled by multiple members at the same time. For such situations, overview screens or webpages are useful.

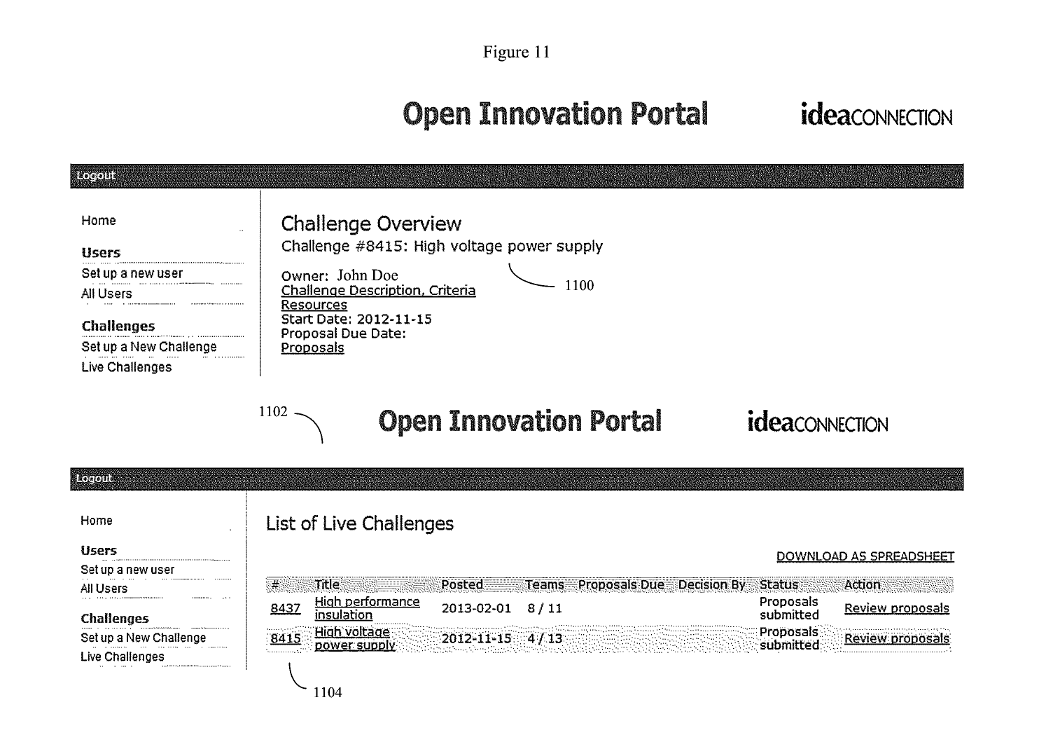

FIG. 11 shows other screens from the client's electronic client workspace, in which the status of this power supply request, and other search requests from this client, can be evaluated at a higher level. In 1100, just the status of a single search is displayed. By contrast, in 1102, the status of two of this client's different scouting request/searches, “High performance insulation” and the “High voltage power supply) (1104) search are displayed on the same screen (1102).

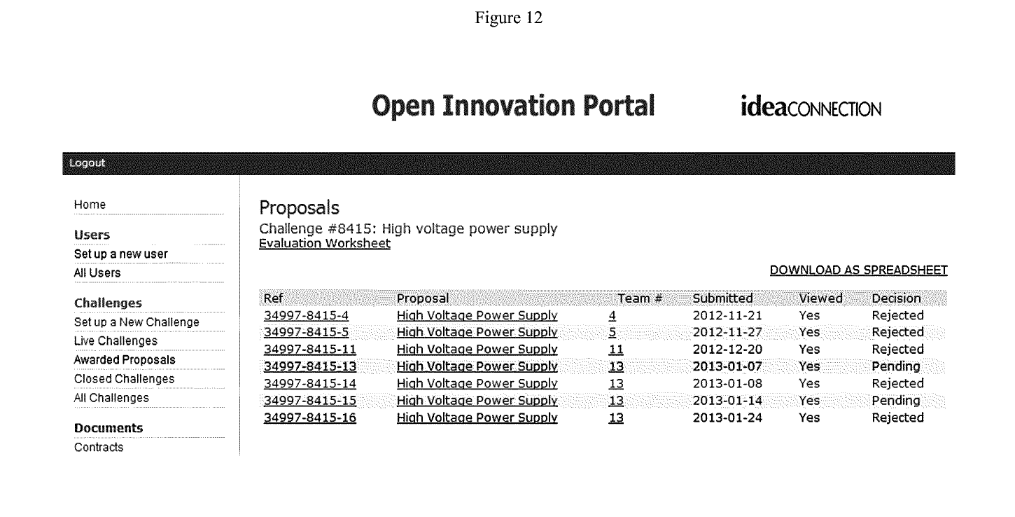

FIG. 12 shows another screen from the client's electronic client workspace, in which this client can review an overview of all of the screened and passing member submissions for one particular high voltage power supply search request, and accept or reject each as desired.

In some embodiments, the system may also provide a “scorecard” webpage or screen to the client. This “scorecard” can, for example, list some or all of the various client-determined criteria for success (along with optional system provided criteria as well). The system can then automatically add the various scores for each criteria, and provide an automated system “score” for each submission. The client can then use this system provided score as a way to help assess the various submitted leads. For example, a client may generally decide spend more time examining high score leads.

Thus upon client approval of any given member lead submission, the client can then, usually through the client's electronic client workspace, transmit a message to the system (104) releasing the payment amount (or other reward) to those members that have provided acceptable leads.

As an optional but often desirable additional step, the client and/or the administrator can further grade or evaluate these members on the quality of their submission, and save these statistics in the member database (100). These statistics can either automatically or manually include such information as the member's total number of scouting request lead submissions, the member's total number of passing scouting request lead submissions, the number of total client approved passing scouting request lead submissions, and so on.

These member statistics can be highly useful. For example, at least for subsequent scouting/searching projects, these member statistics can be used for multiple purposes. The statistics may be used to evaluate the overall success rate of the member's previous lead submissions and those leads from members with good statistics may be automatically passed directly to the client, without the need for further administrator review and approval. The statistics may also be used to help pre-select or pre-screen members for new search projects so that for example, for any given scouting request/search, a client or administrator may specify that only members with good statistics may be selected.

### Other Embodiments

Although all of the specific figures and examples shown so far have been in English, the utility of the system can be significantly extended by providing server (104) with an automatic machine translation capability (supplemented by administrator input as desired). Such automatic machine translation capability can be provided, for example, by using various commercially available translator application programming interfaces (API), such as the Google Translate API. This machine translation capability can, for example, allow the system to work with many non-English speaking clients, members, and sources.

For example, in today's world, much valuable economic activity takes place in various non-English speaking countries, such as China, Japan, Korea, Russia, Germany, France, and the like. Thus machine translation capability expands the network of clients, members, and also member networks that can be employed in any given search.

Thus, for example, in the case where at least some of the members have a primary or native language other than the client's native primary or native language (e.g. client speaks English, while the member only speaks Chinese), the system can use machine translation methods to electronically translate at least some of the non-confidential or confidential scouting requests, scouting invitation, or other documents into that member's primary or native language (e.g. translate English scouting materials to Chinese).

Further, if the member's scouting request lead submission is in turn submitted in a language other than the client's primary or native language (e.g. member submits a lead written in Chinese, and the client only speaks English), the system may also automatically translate the scouting request lead submission into the client's primary or native language.

Here, as previously discussed, in some embodiments, human administrators (116) with the appropriate language skills may optionally review the accuracy of the machine translation, and make corrections as needed.

Other embodiments and related concepts are also discussed in copending application Ser. No. 13/763,714, “METHOD OF MANAGING A CONFIDENTIAL MODERATED CROWDSOURCE PROBLEM SOLVING SYSTEM” and application 61/756,596, “A low risk method for solving complex R&D problems and obtaining highly innovative solutions”; the contents of these applications are incorporated herein by reference.

1. A computerized method of managing a multi-member based scouting process, said method comprising:
storing a plurality of members and associated member information in a member computer database, and providing each member with a unique member electronic workspace;
providing, on a per-client basis, an unique electronic client workspace for scouting requests, obtaining client submitted scouting requests from said electronic client workspace, and storing a plurality of client submitted scouting requests in a scouting request computer database, each scouting request having a non-confidential part, a confidential part, request constraints, and a payment amount;
fulfilling at least one scouting request by:
using said scouting request and said request constraints to search said member computer database for those pre-selected members with associated member information that satisfies said request constraints, and transmitting the non-confidential part of said scouting request to said pre-selected members; or
displaying the non-confidential part of said scouting request on a web page available to said members;
for those responding members, transmitting a scouting invitation comprising an unsigned NDA agreement, and upon receipt of said signed NDA agreement, transmitting said confidential part of said scouting request to said responding members, thus creating NDA responding members;
for at least those NDA responding members who subsequently submit a scouting request lead, using a computer processor to display a list of these lead submitting NDA responding members in a dashboard GUI, along with at least some information pertaining to the date of their scouting request lead submission, link to their said scouting request lead submission, verification status of their scouting request lead submission, and client acceptance of their scouting request lead submission;
verifying which said scouting request lead submissions further pass said request constraints and system default constraints;
using said dashboard GUI to transmit the passing scouting request lead submissions to the client's electronic client workspace, and requesting client approval of said passing scouting request lead submission;
upon client approval of said passing scouting request lead submission, then transmitting said approval to those members that provided said passing scouting request lead submissions.

2. The method of claim 1, wherein at least some of said members obtain said scouting request leads through the member's own computerized or non-computerized social networks.

3. The method of claim 1, wherein said scouting requests are for licensable or other acquirable intellectual property or for requests for quotations from providers of goods or services;
said request constraints comprise a requirement for contact information for the owners or managers of said licensable intellectual property or said providers of products or services;
and wherein said verification comprises contacting said owners or managers and requesting said owners or managers affirm said scouting request lead submissions.

4. The method of claim 1, wherein said scouting requests are for licensable intellectual property or for requests for quotations from providers of goods or services;
said request constraints comprise a requirement for contact information for the owners or managers of said licensable intellectual property or said providers of products or services;
and wherein said verification comprises using said contact information to electronically search at least one of the websites, patents, patent applications, or publications identified by said contact information for key words from said non-confidential or confidential part of said scouting requests.

5. The method of claim 1, wherein said scouting requests are for prior art citations;
said request constraints comprise either an electronic link to said prior art citation or an electronic copy of said prior art citation;
wherein said verification comprises electronically searching said electronic link or electronic copy of said prior art citations for key words from said non-confidential or confidential part of said scouting request.

6. The method of claim 1, wherein at least some of said members have a member primary or native language other than said client's native primary or native language, further electronically translating at least one of the non-confidential or confidential scouting request, scouting invitation, or NDA into said member primary or native language;
wherein if said scouting request lead submission is in a language other than said client's primary or native language, translating said scouting request lead submission into said client's primary or native language.

7. The method of claim 1, further evaluating at least said NDA responding members on the statistics of at least their number of scouting request lead submissions, their number of passing scouting request lead submissions, and the number of client approved passing scouting request lead submissions, recording said statistics in said member computer database along with said member associated information, and using said statistics to further determine said pre-selected members.

8. The method of claim 1, wherein said system default constraints comprise at least one of electronic form consistency testing, electronic form completeness testing, or email, phone number, or URL verification.

9. The method of claim 1, wherein said request constraints comprise at least one of constraints on said member geographic location, constraints on said member present or past employers, constraints on said member educational level.

10. The method of claim 1, wherein said request constraints comprise at least one of constraints that scouting request lead submissions further comprise patented technology, affirmation of interest in partnership, affirmation of interest in licensing, affirmation of interest in exclusive licensing, affirmation of interest in selling affirmation of interest in providing products, or affirmation of interest in providing services.

11. The method of claim 1, wherein said clients may use said electronic client workspace to answer questions from said NDA responding members, or transmit alterations or corrections for said confidential part of said scouting request to said NDA responding members.

12. The method of claim 1, further using a web server to provide said electronic client workspace or said unique member electronic portal as one or more web pages or app screens over the Internet, and wherein said client and said members interact with said electronic client workspace or said unique member electronic portal over the Internet using web browsers or application software running on client or worker computerized devices connected to the Internet.

13. A computerized method of managing a multi-member based scouting process, said method comprising:
storing a plurality of members and associated member information in a member computer database, and providing each member with a unique member electronic workspace;
providing, on a per-client basis, an unique electronic client workspace for scouting requests, obtaining client submitted scouting requests from said electronic client workspace, and storing a plurality of client submitted scouting requests in a scouting request computer database, each scouting request having a non-confidential part, a confidential part, request constraints, and a payment amount;
fulfilling at least one scouting request by:
using said scouting request and said request constraints to search said member computer database for those pre-selected members with associated member information that satisfies said request constraints, and transmitting the non-confidential part of said scouting request to said pre-selected members; or
displaying the non-confidential part of said scouting request on a web page available to said members;
for those responding members, transmitting a scouting invitation comprising an unsigned NDA agreement, and upon receipt of said signed NDA agreement, transmitting said confidential part of said scouting request to said responding members, thus creating NDA responding members;
for at least those NDA responding members who subsequently submit a scouting request lead, using a computer processor to display a list of these lead submitting NDA responding members in a dashboard GUI, along with at least some information pertaining to the date of their scouting request lead submission, link to their said scouting request lead submission, verification status of their scouting request lead submission, and client acceptance of their scouting request lead submission;
wherein at least some of said members obtain said scouting request leads through the member's own computerized or non-computerized social networks;
verifying which said scouting request lead submissions further pass said request constraints and system default constraints;
wherein said clients may use said electronic client workspace to answer questions from said NDA responding members, or transmit alterations or corrections for said confidential part of said scouting request to said NDA responding members;
using said dashboard GUI to transmit the passing scouting request lead submissions to the client's electronic client workspace, and requesting client approval of said passing scouting request lead submission;
upon client approval of said passing scouting request lead submission, then transmitting said approval to those members that provided said passing scouting request lead submissions;
using a web server to provide said electronic client workspace or said unique member electronic portal as one or more web pages or app screens over the Internet, and wherein said client and said members interact with said electronic client workspace or said unique member electronic portal over the Internet using web browsers or application software running on client or worker computerized devices connected to the Internet;
further evaluating at least said NDA responding members on the statistics of at least their number of scouting request lead submissions, their number of passing scouting request lead submissions, and the number of client approved passing scouting request lead submissions, recording said statistics in said member computer database along with said member associated information, and using said statistics to further determine said pre-selected members.

14. The method of claim 13, wherein said scouting requests are for licensable or other acquirable intellectual property or for requests for quotations from providers of goods or services;
said request constraints comprise a requirement for contact information for the owners or managers of said licensable intellectual property or said providers of products or services;
and wherein said verification comprises contacting said owners or managers and requesting said owners or managers affirm said scouting request lead submissions.

15. The method of claim 13, wherein said scouting requests are for licensable intellectual property or for requests for quotations from providers of goods or services;
said request constraints comprise a requirement for contact information for the owners or managers of said licensable intellectual property or said providers of products or services;
and wherein said verification comprises using said contact information to electronically search at least one of the websites, patents, patent applications or publications identified by said contact information for key words from said non-confidential or confidential part of said scouting requests.

16. The method of claim 13, wherein said scouting requests are for prior art citations;
said request constraints comprise either an electronic link to said prior art citation or an electronic copy of said prior art citation;
wherein said verification comprises electronically searching said electronic link or electronic copy of said prior art citations for key words from said non-confidential or confidential part of said scouting request.

17. The method of claim 13, wherein at least some of said members have a member primary or native language other than said client's native primary or native language, further electronically translating at least one of the non-confidential or confidential scouting request, scouting invitation, or NDA into said member primary or native language;
wherein if said scouting request lead submission is in a language other than said client's primary or native language, translating said scouting request lead submission into said client's primary or native language.

18. The method of claim 13, wherein said system default constraints comprise at least one of electronic form consistency testing, electronic form completeness testing, electronic social network connection verification, electronic search engine verification, or email, phone number, or URL verification.

19. The method of claim 13, wherein said request constraints comprise at least one of constraints on said member geographic location, constraints on said member present or past employers, constraints on said member educational level.

20. The method of claim 13, wherein said request constraints comprise at least one of constraints that scouting request lead submissions further comprise patented technology, affirmation of interest in partnership, affirmation of interest in licensing, affirmation of interest in exclusive licensing, affirmation of interest in selling affirmation of interest in providing products, or affirmation of interest in providing services.
